(19) United States
(12) Patent Application Publication
(10) Pub. No.: US 2017/0132762 A1
(43) Pub. Date: May 11, 2017

(54) METHOD AND DEVICE FOR GENERATING STENCIL MATRICES AND SYNTHESIZING PARKING IMAGES

(71) Applicant: Leauto Intelligent Technology (BEIJING) Co. Ltd., Beijing (CN)

(72) Inventors: Xun ZHOU, Beijing (CN); ChengJie ZANG, Beijing (CN)

(21) Appl. No.: 14/979,118

(22) Filed: Dec. 22, 2015

(30) Foreign Application Priority Data
Nov. 6, 2015 (CN) 201510753712.5

(51) Int. Cl. G06T 5/00; B60R 1/00; H04N 5/232

(52) U.S. Cl. CPC G06T 5/002; H04N 5/23238; B60R 1/00; G06T 2207/20221; G06T 2207/30264; B60R 2300/806; B60R 2300/30

(57) ABSTRACT

The embodiments of the present disclosure provide a method, a system, and a panoramic apparatus for mitigating color mutation in image fusion. The method may include: acquiring a plurality of top-view images to be synthesized, wherein each of the plurality of top-view images is corresponding to a parking camera respectively, the resolution of the first top-view images is same as the resolution of a preset object panoramic parking image; generating a plurality of stencil matrices corresponding to the plurality of first top-view images by identifying overlapping regions between effective pixel regions of the first top-view images, calculating overlapping weight value of each first top-view image in the overlapping regions and setting element values of matrix elements in the stencil matrices corresponding the pixel points as the overlapping weight values; and storing the generated a plurality of stencil matrices as system call files for subsequent synthesis of parking images.

### CROSS-REFERENCE TO RELATED APPLICATIONS

This application is based on and claims priority to Chinese Patent Application No. 201510753712.5, with the title of “METHOD AND DEVICE FOR GENERATING STENCIL MATRICES AND SYNTHESIZING PARKING IMAGES”, filed on Nov. 6, 2015, the full disclosure of which is hereby incorporated by reference in its entirety.

### TECHNICAL FIELD

The present disclosure is related to methods and devices for generating matrices and synthesizing images, and more particularly to a method and a device for generating stencil matrices and synthesizing parking images.

### BACKGROUND

Recently, as the people's demands on safe driving grow, normal rear view system has been unable to meet people's daily needs more and more. Therefore, a 360-degree view parking system, which may intuitively show a view of 360-degree around scene without dead spots, has been developed. However, by now, the panoramic images of the commercially available 360-degree view parking systems are obtained by simply performing image synthesis on the top-view image of different directions, i.e., by performing position matching on captured images, which have been subject to simple correction and transformation, and directly synthesizing these images into one image. However, there may be obvious splicing marks in overlapping regions of images from different cameras, and thus the experiences of users may be degraded.

There are some synthesis processing methods proposed with respect to the parking images in the related art, but the efficiency of processing may be often degraded during the synthesis processing of parking images in real-time, which may render the parking system being unable to work in real-time.

### SUMMARY

The object of the present disclosure is to provide a method and a device for generating stencil matrices and synthesizing parking images, so as to improve the efficiency of synthesis processing for parking images.

To achieve the above object, the present disclosure may provide a method for generating stencil matrices, including: acquiring a plurality of top-view images to be synthesized, wherein each of the plurality of top-view images is corresponding to a parking camera respectively, the resolution of the first top-view images is same as the resolution of a preset object panoramic parking image; generating a plurality of stencil matrices corresponding to the plurality of first top-view images by identifying overlapping regions between effective pixel regions of the first top-view images, calculating overlapping weight value of each first top-view image in the overlapping regions and setting element values of matrix elements in the stencil matrices corresponding the pixel points as the overlapping weight values, the effective pixel regions being pixel regions where there are actual captured images; and storing the generated a plurality of stencil matrices as system call files for subsequent synthesis of parking images.

The present disclosure may also provide a method for synthesizing parking images, including: acquiring a plurality of same second top-view images to be synthesized, each of the plurality of second top-view images may be corresponding to a parking camera respectively, the resolution of the second top-view images is same as the resolution of a preset object panoramic parking image; calling a plurality of stencil matrices stored in advance, overlapping weight values corresponding to pixel points of the second top-view images being stored in matrix element of the stencil matrices, wherein the overlapping weight values mean ratios of pixel values of pixel points of each second top-view image of overlapping regions between effective pixel regions in the synthesized panoramic parking images, the effective pixel regions being pixel regions where there are actual captured images; multiplying pixel values in the plurality of second top-view images and element values corresponding to the plurality of stencil matrices respectively to generate a plurality of third top-view images; and overlapping and synthesizing the plurality of third top-view images to generate the panoramic parking image.

The present disclosure may also provide a device for generating stencil matrices including: a first acquiring module configured to acquire a plurality of first top-view images to be synthesized, wherein each of the plurality of top-view images is corresponding to a parking camera respectively, the resolution of the first top-view images is same as the resolution of a preset object panoramic parking image; a matrix generating module configured to generate a plurality of stencil matrices corresponding to the plurality of first top-view images by identifying overlapping regions between effective pixel regions of the first top-view images, calculating overlapping weight value of each first top-view image in the overlapping regions and setting element values of matrix elements in the stencil matrices corresponding the pixel points as the overlapping weight values, the effective pixel regions being pixel regions where there are actual captured images; and a storing module configured to store the generated a plurality of stencil matrices as system call files for subsequent synthesis of parking images.

The present disclosure may also provide a device for synthesizing parking images, including: a second acquiring module configured to acquire a plurality of same second top-view images to be synthesized, each of the plurality of second top-view images may be corresponding to a parking camera respectively, the resolution of the second top-view images is same as the resolution of a preset object panoramic parking image; a calling module configured to call a plurality of stencil matrices stored in advance, overlapping weight values corresponding to pixel points of the second top-view images being stored in matrix element of the stencil matrices, wherein the overlapping weight values mean ratios of pixel values of pixel points of each second top-view image of overlapping regions between effective pixel regions in the synthesized panoramic parking images, the effective pixel regions being pixel regions where there are actual captured images; a multiplying module configured to multiply pixel values in the plurality of second top-view images and element values corresponding to the plurality of stencil matrices respectively to generate a plurality of third top-view images; and a synthesizing module configured to overlap and synthesize the plurality of third top-view images to generate the panoramic parking image.

The present disclosure may also provide a device for generating stencil matrices, comprising: one or more processors; a memory; and one or more programs stored in the memory and configured to perform operations when executed by the one or more processors, wherein the operations comprise: acquiring a plurality of top-view images to be synthesized, wherein each of the plurality of top-view images is corresponding to a parking camera respectively, the resolution of the first top-view images is same as the resolution of a preset object panoramic parking image; generating a plurality of stencil matrices corresponding to the plurality of first top-view images by identifying overlapping regions between effective pixel regions of the first top-view images, calculating overlapping weight value of each first top-view image in the overlapping regions and setting element values of matrix elements in the stencil matrices corresponding the pixel points as the overlapping weight values, the effective pixel regions being pixel regions where there are actual captured images; and storing the generated a plurality of stencil matrices as system call files for subsequent synthesis of parking images.

The present disclosure may also provide a device for synthesizing parking images, comprising: one or more processors; a memory; and one or more programs stored in the memory and configured to perform operations when executed by the one or more processors, wherein the operations comprise: acquiring a plurality of same second top-view images to be synthesized, wherein each of the plurality of second top-view images is corresponding to a parking camera respectively, the resolution of the second top-view images is same as the resolution of a preset object panoramic parking image; calling a plurality of stencil matrices stored in advance, overlapping weight values corresponding to pixel points of the second top-view images being stored in matrix element of the stencil matrices, wherein the overlapping weight values mean ratios of pixel values of pixel points of each second top-view image of overlapping regions between effective pixel regions in the synthesized panoramic parking images, the effective pixel regions being pixel regions where there are actual captured images; multiplying pixel values in the plurality of second top-view images and element values corresponding to the plurality of stencil matrices respectively to generate a plurality of third top-view images; and overlapping and synthesizing the plurality of third top-view images to generate the panoramic parking image.

The methods and devices for generating stencil matrices and synthesizing parking images of the present disclosure may generate stencil matrices for synthesis processing of parking images generated in advance in a off-line state and store the same as system files so that these stencil matrices may be applied in subsequent real-time synthesis, and therefore the efficiency of synthesis processing of parking images in on-line state may be improved.

### BRIEF DESCRIPTION OF THE DRAWINGS

FIG. 1 is a schematic diagram of an image synthesis principle of the 360-degree parking system of the present disclosure.

FIG. 2 is another schematic diagram of an image synthesis principle of the 360-degree parking system of the present disclosure.

FIG. 3 is a schematic flowchart of the method for generating stencil matrices of the first embodiment of the present disclosure.

FIG. 4 is a schematic diagram of a principle for calculating overlapping weight values of the first embodiment of the present disclosure.

FIG. 5 is a schematic flowchart of the method for synthesizing parking images of the second embodiment of the present disclosure.

FIG. 6 is a schematic diagram of a principle for synthesizing parking images of the second embodiment of the present disclosure.

FIG. 7 is structural schematic diagram of the device for generating stencil matrices of the third embodiment of the present disclosure.

FIG. 8 is a structural schematic diagram of the device for synthesizing parking images of the fourth embodiment of the present disclosure.

FIG. 9 is a structural view of an embodiment of a device for synthesizing parking images provided by the present disclosure.

### DESCRIPTION OF THE EMBODIMENTS

In the following, description in detail would be made on the embodiments of the present disclosure in connection with the drawings.

The principle of the present disclosure may be described as follows: stencil matrices for synthesis processing of parking images may be generated in off-line state, before synthesis processing of parking images in on-line state, and then the stencil matrices may be stored. When the synthesis processing of parking images is performed in real-time in on-line state, the stored stencil matrices may be called for image synthesis processing, and thereby the efficiency of synthesis processing of parking images in on-line state may be improved. In the embodiments of the present disclosure, the on-line state may refer to the working state when a real-time system is running, and the off-line state may refer to states of making tests, modulating or setting, for example, the initializing mode, modulating mode or the like used before shipping or when the system is used for the first time.

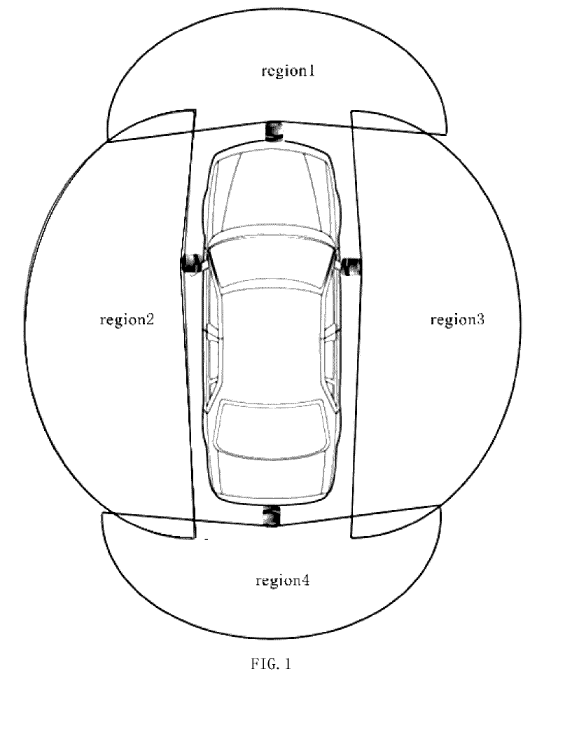

The common applying scene for synthesis processing of parking images is shown in FIG. 1. For example, in the case that four images captured by four parking cameras are synthesized into a panoramic parking image, the images captured by the four parking cameras may be processed to generate top-view images surrounding vehicle (the image of the vehicle itself may be in the middle and may be regarded as being unnecessary for synthesis or splicing processing). For the sake of description, the regions may be labeled as regions 1 to 4 respectively.

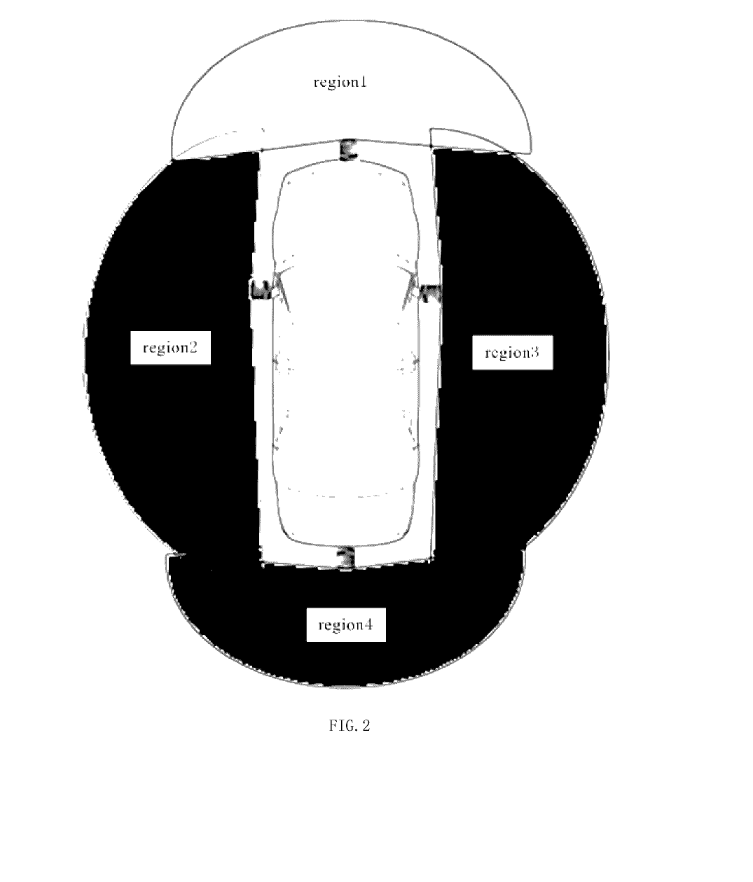

The basis procedure of image synthesis may be described as follows: four original images may be preprocessed to generate four top-view images, and then the four top-view images may be subject to image filling processing according to the size of object panoramic image to be generated at last (i.e., the size of object panoramic image), so as to generate a image with a size same as the size of the final panoramic image. Since it is possible for any of these four top-view images to show all of the panoramic image, it is necessary to make filling with respect to the parts not being captured (normally filled with black color, as shown in FIG. 2) so as to generate an image with a size same as the size of the final panoramic image, and thereby the image with a size same as the size of the panoramic parking image may be generated. For example, the front-view parking camera may only capture images of the front region 1, but the parts corresponding to other regions may be filled with black color in order to generate the image with a size same as the size of the panoramic parking image. Likewise, the other three images may be subject to the same filling processing so that four images to be synthesized into the final panoramic image are generated, and then these four images may be overlapped and synthesized so that the panoramic image surrounding the vehicle as shown in FIG. 1 may be generated.

Furthermore, for the sake of description on technical solution of the embodiments of the present disclosure, the top-view image processed in off-line state may be referred as the first top-view image, and the top-view image processed in on-line state may be referred as the second top-view image.

### First Embodiment

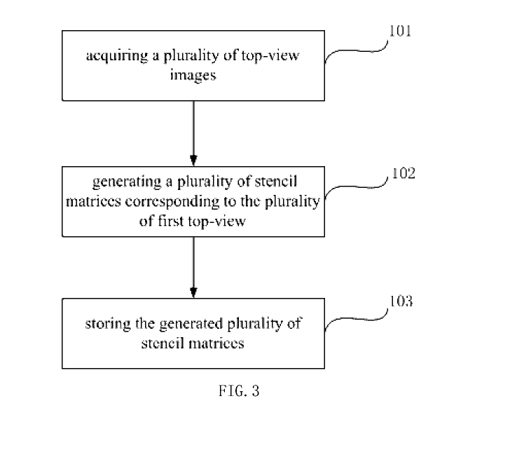

As shown in FIG. 3, which is a schematic flowchart of the method for generating stencil matrices of the first embodiment of the present disclosure, the method for generating stencil matrices of the present embodiment may include:

Step 101, acquiring a plurality of top-view images to be synthesized, wherein each of the plurality of top-view images is corresponding to a parking camera respectively, the resolution of the first top-view images is same as the resolution of a preset object panoramic parking image.

Step 102, generating a plurality of stencil matrices corresponding to the plurality of first top-view images by identifying overlapping regions between effective pixel regions of the first top-view images, calculating overlapping weight value of each first top-view image in the overlapping regions and setting element values of matrix elements in the stencil matrices corresponding the pixel points as the overlapping weight values, wherein the overlapping weight values mean ratios of pixel values of pixel points of each second top-view image of overlapping regions between effective pixel regions in the synthesized panoramic parking images, and the effective pixel regions being pixel regions where there are actual captured images, for example, region 1 in FIG. 2.

The stencil matrices of the embodiment of the present disclosure are mainly used to perform image synthesis on pixel values of pixel points of overlapping regions according to the overlapping weight value, but it is necessary for the pixel points outside of the overlapping regions to be subject to image synthesis processing. Therefore, the values in stencil matrices corresponding to these pixel points may be set as 1, i.e., only the pixel values of the pixel points in overlapping regions may be changed after the first top-view image is multiplied with the stencil matrices.

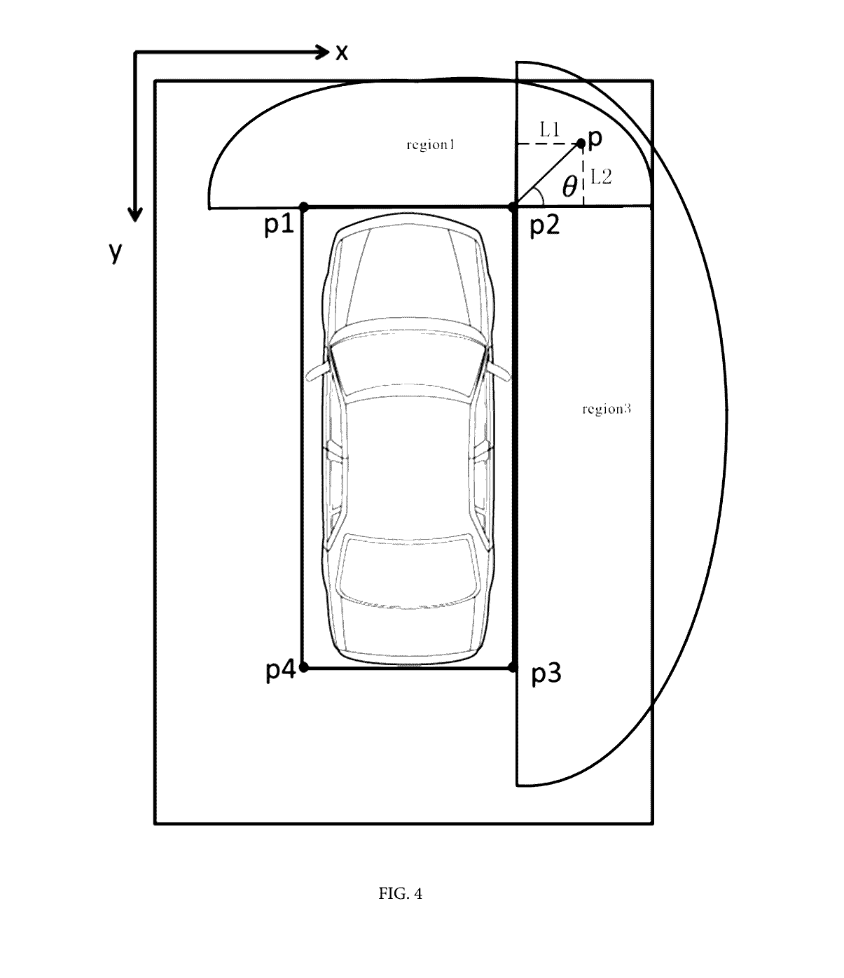

In this step, the overlapping weight values may be calculated by an average weight method or distance weight method or angle weight method. More particularly, the calculating principle of the angle weight method may be shown in FIG. 4, in which preset marked point arranged in space may be P1 to P4. With reference to FIG. 1, it may be seen that, the point P in FIG. 4 is in the overlapping region of the region 1 which can be captured by the front-view camera and the region 3 which can be captured by the right-view camera. In this case, at point P, overlapping weight values for the front-view camera to capture the pixel points in the first top-view image may be M₁(P)=sin θ, M₃(P)=cos θ. The distance weight method may use a ratio value of the distances of point P to the line connected between points P3 and P3 to calculate the weight. Also as shown in FIG. 4, the vertical distance from point P1 to the line connected between P3 and P2 may be represented by L1, and the vertical distance from P1 to the line connected between P1 and P2 may be represented by L2. Therefore, at point P, the overlapping weight values for the front-view camera to capture the pixel points in the first top-view image may be

$${M}_{1} ( P ) = \frac{L 1}{L 2} , {M}_{3} ( P ) = 1 - {M}_{1} ( P ) .$$

The average weight method may divide the overlapping weight value of the pixel points corresponding to point P equally, i.e. M₁(P)=0.5, M₃(P)=0.5. The above description exemplarily shows several calculation methods for overlapping weight value. Each calculation method may be adjusted according to actual circumstances without limitation of the above example. For example, the case shown in FIG. 4 may be the case of overlapping regions captured by only two cameras. In fact, overlapping weight values may be calculated in the case of overlapping regions captured by more than two cameras, as long as it may be ensured that the overlapping weight values of all pixel points corresponding to the same pixels may be added up to 1.

Step 103, storing the generated a plurality of stencil matrices as system call files for subsequent synthesis of parking images.

Through the above steps 101 to 103, a plurality of stencil matrices, which may be used repeatedly, can be generated. After these stencil matrices are stored in the system of the vehicle, they may be called immediately when a parking image synthesis processing is performed in real-time in on-line state afterwards, and it would be unnecessary to perform identification of image overlapping regions and image synthesis processing, and thereby the efficiency of image synthesis processing in on-line state may be improved.

In a practical application, in the above step 102, the processing for generating a plurality of stencil matrices corresponding to a plurality of first top-view images may be the following procedure:

All pixel points of all first top-view images may be subject to the following processing so as to generate a plurality of stencil matrices corresponding to a plurality of first top-view images.

1) When it is currently determined that the pixel value of the first pixel point is zero (i.e., the pixel point exhibits black color), the elementary value at corresponding position in the stencil matrices corresponding to the first top-view image may be set to 0 or 1.

There are two possibilities for such case. One is the case that pixel may be located in a region filled with black (such as regions 2 to 4 in FIG. 2). The other is the case that the points in the image actually captured corresponding to this part may be black. Since the pixel value of the pixel point is 0, the corresponding elementary values in stencil matrices would not pose any influence on this pixel point whatever it is set to any value. However, as a general image processing manner, the elementary value may be set to 0 or 1.

2) If the pixel values of the first pixel points are not 0, and pixel values of all second pixel points whose positions are same as positions of the first pixel points in all other first top-view images are 0, the elementary value may be set to 1. In this case, the first pixel point is located in effective pixel region outside of the overlapping region.

3) If pixel values of the first pixel point are not 0, and there are second pixel points whose pixel values are not 0, the overlapping weight values of pixel values of the first pixel points with respect to pixel values of other second pixel points may be calculated, and the first elementary value may be set as the overlapping weight value. In this case, the first pixel point is located in the overlapping region.

The processing of the above step 102 may be described with following mathematic model.

Assuming that N first top-view image I₁(x,y), I₂(x,y), . . . , I_{N}(x,y) with resolution of H×W are acquired in step 101, and the N stencil matrices corresponding thereto may be represented as M₁(x,y), M₂(x,y), . . . , M_{N}(x,y) respectively, wherein, x, y may be row and column coordinates of corresponding pixel of images or corresponding matrix elements of matrices respectively, and x∈[0,H), y∈[0,W).

Regarding any stencil matrix Mₙ(x,y), n∈[1,N], it is necessary to perform processing on all pixel points of all first top-view image Iₙ(x,y), x∈[0,H], y∈[0,W]. The value of matrix elements of the stencil matrix Mₙ(x,y) may be calculated according to the following rule.

A) If Iₙ(x,y)=0, Mₙ(x,y)=0 or Mₙ(x,y)=1. In the image processing, if the pixel value is 0, it means that this position is black.

B) If Iₙ(x,y)≠0 and all other Iₘ(x,y)=0, m∈[1,N], m≠n, Mₙ(x,y)=1.

C) If Iₙ(x,y)=0, and Iₙ(x,y)≠0, the weight value P at this pixel point of the first top-view image may be calculated, and Mₙ(x,y)=P.

Step 103, storing the generated plurality of stencil matrices as system call files for subsequent synthesis of parking images.

Furthermore, in the above step 101, the processing of acquiring a plurality of first top-view images to be synthesized may include: receiving a plurality of first original images captured by a plurality of parking cameras, and performing distortion correction on the plurality of first original images, and at last, the plurality of first original images subject to the distortion correction processing may be subject to angle-perspective transformation and image filling processing according to the coordinates of preset mark points arranged in space and preset resolution and size of object panoramic parking image, so as to generate a plurality of first top-view image.

The processing of the present embodiment are mainly used in off-line state, for example, in an initializing mode used before shipping or when the system is used for the first time, or in a modulating mode, to perform the processing of the present embodiment, and thereby the files of stencil matrices for on-line state may be generated.

### Second Embodiment

FIG. 5 is a schematic flowchart of the method for synthesizing parking images of the second embodiment of the present disclosure. As shown in FIG. 5, the method for synthesizing parking images of the present embodiment may include:

Step 201, acquiring a plurality of same second top-view images to be synthesized, each of the plurality of second top-view images corresponding to a parking camera respectively, the resolution of the second top-view images being same as the resolution of a preset object panoramic parking image. For example, the second top-view images may be represented as I₁(x,y), I₂(x,y), . . . , I_{N}(x,y).

Step 202, calling a plurality of stencil matrices stored in advance, overlapping weight values corresponding to pixel points of the second top-view images being stored in matrix element of the stencil matrices, wherein the overlapping weight values mean ratios of pixel values of pixel points of each second top-view image of overlapping regions between effective pixel regions in the synthesized panoramic parking images, the effective pixel regions being pixel regions where there are actual captured images. More particularly, the stencil matrices herein may be the stencil matrices generated by the method for generating stencil matrices of the first embodiment. More particularly, with reference to the example of the first embodiment, the files of stencil matrices may be represented as M₁(x,y), M₂(x,y), . . . , M_{N}(x,y).

Step 203, multiplying pixel values in the plurality of second top-view images and element values corresponding to the plurality of stencil matrices respectively to generate a plurality of third top-view images.

Step 204, overlapping and synthesizing the plurality of third top-view images to generate the panoramic parking image.

The processing of above step 203 and step 204 may be represented as: final panoramic parking images=M₁(x,y)×I₁(x,y)+M₂(x,y)×I₂(x,y)+ . . . +M_{N}(x,y)×I_{N}(x,y). The matrix multiplying processing mentioned in the embodiment of the present disclosure may be a multiplying processing for multiplying each matrix element of the stencil matrix and the pixel points of the second top-view image one by one.

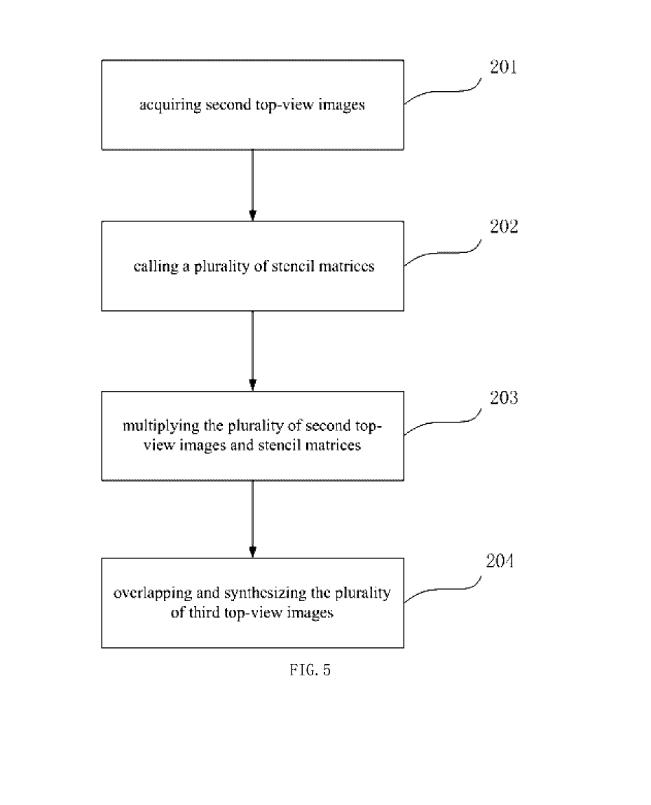

FIG. 6 is a schematic diagram of a principle for synthesizing parking images of the second embodiment of the present disclosure. FIG. 6 shows the procedure of the processing of the present embodiment. During the on-line processing, stencil matrices may be mainly used to be multiplied with each second top-view image and then synthesis may be performed, and thereby the final panoramic parking image may be generated.

The method for synthesizing parking images of the present embodiment may perform processing for synthesizing parking images by calling pre-generated stencil matrices in on-line state. More particularly, most of work may be matrix multiplication without complicated image synthesis algorithms. Therefore, the consumption of system resources may be reduced and the real-time capability of the algorithm may be ensured.

Furthermore, in the above step 201, the processing of acquiring a plurality of first top-view images to be synthesized may include: receiving a plurality of second original images captured by a plurality of parking cameras, and performing distortion correction on the plurality of second original images, and at last, the plurality of second original images subject to the distortion correction processing may be subject to angle-perspective transformation and image filling processing according to the coordinates of preset mark points arranged in space and preset resolution and size of object panoramic parking image, so as to generate a plurality of second top-view image with same resolution.

### Third Embodiment

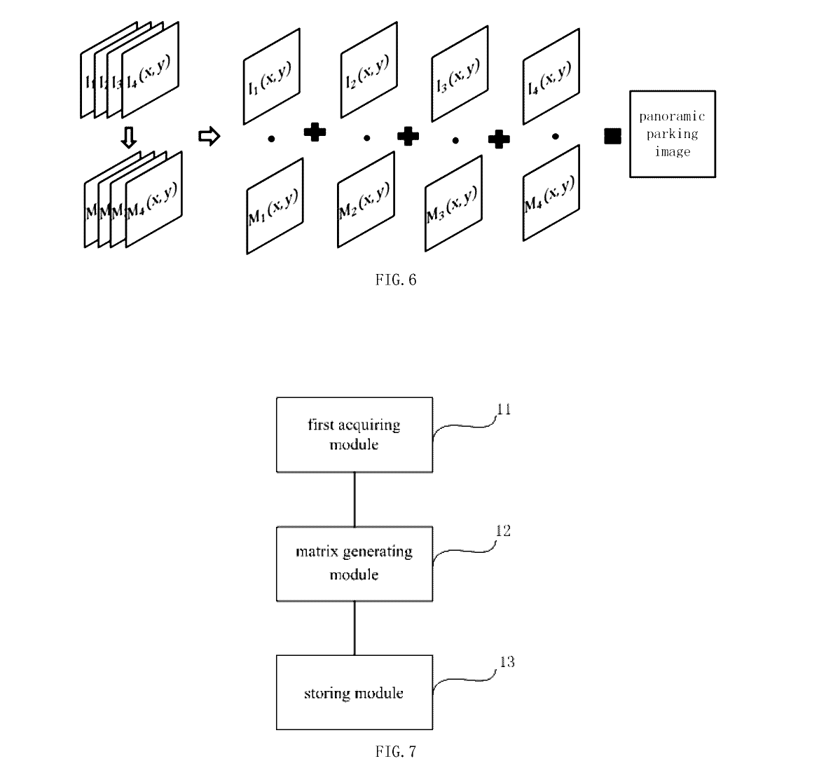

As shown in FIG. 7, which is a structural schematic diagram of the device for generating stencil matrices of the third embodiment of the present disclosure, the device for generating stencil matrices of the present embodiment may include a first acquiring module 11, a matrix generating module 12, and storing module 13.

The first acquiring module 11 may be configured to acquire a plurality of first top-view images to be synthesized, wherein each of the plurality of top-view images is corresponding to a parking camera respectively, the resolution of the first top-view images is same as the resolution of a preset object panoramic parking image.

The matrix generating module 12 may be configured to generate a plurality of stencil matrices corresponding to the plurality of first top-view images by identifying overlapping regions between effective pixel regions of the first top-view images, calculating overlapping weight value of each first top-view image in the overlapping regions and setting element values of matrix elements in the stencil matrices corresponding the pixel points as the overlapping weight values, the effective pixel regions being pixel regions where there are actual captured images.

The storing module 13 may be configured to store the generated a plurality of stencil matrices as system call files for subsequent synthesis of parking images.

More particularly, the first acquiring module 11 may include: a first receiving unit, a first distortion correction unit, and a first top-view image generating unit.

The first receiving unit may be configured to receive a plurality of first original images captured by a plurality of parking cameras. The first distortion correction unit may be configured to perform distortion correction on the plurality of first original images. And the first top-view image generating unit may be configured to perform angle-perspective transformation and image filling processing on the plurality of first original images subject to the distortion correction processing according to the coordinates of preset mark points arranged in space and preset resolution and size of object panoramic parking image, so as to generate a plurality of first top-view image.

The device for generating stencil matrices of the present embodiment may generate a plurality of stencil matrices, which may be used repeatedly, in off-line state. After these stencil matrices are stored in the system of the vehicle, they may be called immediately when a parking image synthesis processing is performed in real-time in on-line state afterwards, and it would be unnecessary to perform identification of image overlapping regions and image synthesis processing, and thereby the efficiency of image synthesis processing in on-line state may be improved

### Fourth Embodiment

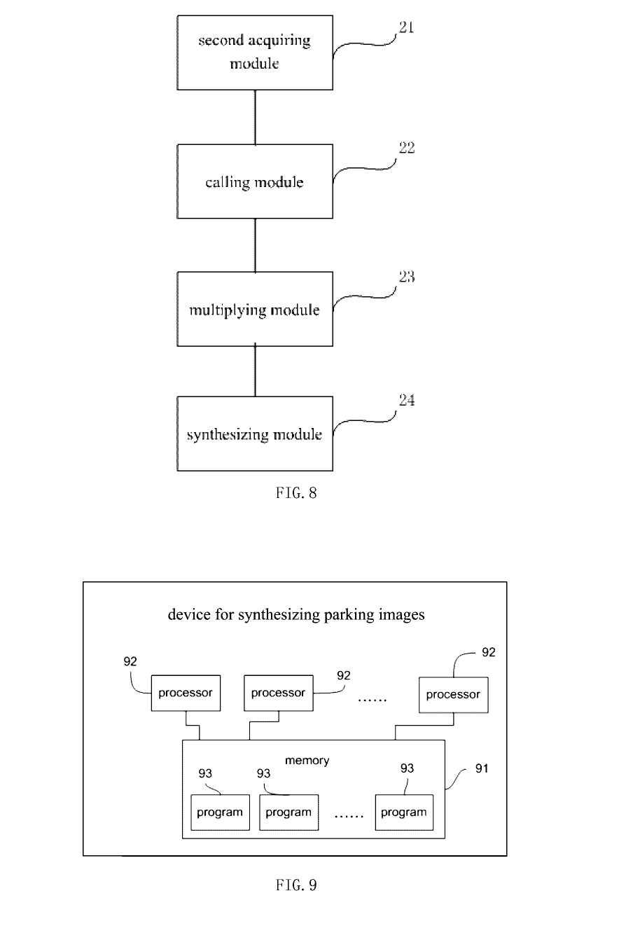

FIG. 8 is a structural schematic diagram of the device for synthesizing parking images of the fourth embodiment of the present disclosure. As shown in FIG. 8, the device for synthesizing parking images may include a second acquiring module 21, a calling module 22, and a multiplying module 23, and a synthesizing module 24.

The second acquiring module 21 may be configured to acquire a plurality of same second top-view images to be synthesized, wherein each of the plurality of second top-view images may be corresponding to a parking camera respectively, the resolution of the second top-view images is same as the resolution of a preset object panoramic parking image.

The calling module 22 may be configured to call a plurality of stencil matrices stored in advance, overlapping weight values corresponding to pixel points of the second top-view images being stored in matrix element of the stencil matrices, wherein the overlapping weight values mean ratios of pixel values of pixel points of each second top-view image of overlapping regions between effective pixel regions in the synthesized panoramic parking images, the effective pixel regions being pixel regions where there are actual captured images.

The multiplying module 23 may be configured to multiply pixel values in the plurality of second top-view images and element values corresponding to the plurality of stencil matrices respectively to generate a plurality of third top-view images.

The synthesizing module 24 may be configured to overlap and synthesize the plurality of third top-view images to generate the panoramic parking image.

More particularly, the second acquiring module 21 may include a second receiving unit configured to receive a plurality of second original images captured by a plurality of parking cameras; a distortion correction unit configured to perform distortion correction on the plurality of second original images; and a third top-view image generating unit configured to perform angle-perspective transformation and image filling processing on the plurality of second original images subject to the distortion correction processing according to the coordinates of preset mark points arranged in space and preset resolution and size of object panoramic parking image, so as to generate a plurality of second top-view image with same resolution.

The device for synthesizing parking images of the present embodiment may perform processing for synthesizing parking images by calling pre-generated stencil matrices in on-line state. More particularly, most of work may be matrix multiplication without complicated image synthesis algorithms. Therefore, the consumption of system resources may be reduced and the real-time capability of the algorithm may be ensured.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, and the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A method for generating stencil matrices, comprising:
acquiring a plurality of top-view images to be synthesized, wherein each of the plurality of top-view images is corresponding to a parking camera respectively, the resolution of the first top-view images is same as the resolution of a preset object panoramic parking image;
generating a plurality of stencil matrices corresponding to the plurality of first top-view images by identifying overlapping regions between effective pixel regions of the first top-view images, calculating overlapping weight value of each first top-view image in the overlapping regions and setting element values of matrix elements in the stencil matrices corresponding the pixel points as the overlapping weight values, the effective pixel regions being pixel regions where there are actual captured images; and
storing the generated a plurality of stencil matrices as system call files for subsequent synthesis of parking images.

2. The method for generating stencil matrices according to claim 1, wherein the generating a plurality of stencil matrices corresponding to the plurality of first top-view images further comprises setting elementary value corresponding to the pixel point outside of the overlapping region to 1.

3. The method for generating stencil matrices according to claim 1, wherein the generating a plurality of stencil matrices corresponding to the plurality of first top-view images further comprises:
performing the following processing on all pixel points of all first top-view images so as to generate a plurality of stencil matrices corresponding to a plurality of first top-view images:
setting the elementary value at corresponding position in the stencil matrix corresponding to the first top-view image to 0 or 1, when it is currently determined that the pixel value of the first pixel point is zero,
setting the elementary value to 1, when the pixel values of the first pixel points are not 0, and pixel values of all second pixel points whose positions are same as positions of the first pixel points in all other first top-view images are 0, and
calculating the overlapping weight values of pixel values of the first pixel points with respect to pixel values of other second pixel points, and setting the first elementary value as the overlapping weight value, when pixel values of the first pixel point are not 0, and there are second pixel points whose pixel values are not 0.

4. The method for generating stencil matrices according to claim 1, wherein the overlapping weight value is calculated by average weight method or distance weight method or angle weight method.

5. The method for generating stencil matrices according to claim 1, wherein the acquiring a plurality of first top-view images to be synthesized comprises:
receiving a plurality of first original images captured by a plurality of parking cameras;
performing distortion correction on the plurality of first original images; and
performing angle-perspective transformation and image filling processing on the plurality of first original images subject to the distortion correction processing according to the coordinates of preset mark points arranged in space and preset resolution and size of object panoramic parking image, so as to generate a plurality of first top-view image.

6. A method for synthesizing parking images, comprising:
acquiring a plurality of same second top-view images to be synthesized, wherein each of the plurality of second top-view images is corresponding to a parking camera respectively, the resolution of the second top-view images is same as the resolution of a preset object panoramic parking image;
calling a plurality of stencil matrices stored in advance, overlapping weight values corresponding to pixel points of the second top-view images being stored in matrix element of the stencil matrices, wherein the overlapping weight values mean ratios of pixel values of pixel points of each second top-view image of overlapping regions between effective pixel regions in the synthesized panoramic parking images, the effective pixel regions being pixel regions where there are actual captured images;
multiplying pixel values in the plurality of second top-view images and element values corresponding to the plurality of stencil matrices respectively to generate a plurality of third top-view images; and
overlapping and synthesizing the plurality of third top-view images to generate the panoramic parking image.

7. The method for synthesizing parking images according to claim 6, wherein the acquiring a plurality of second top-view images to be synthesized with same resolution comprises:
receiving a plurality of second original images captured by a plurality of parking cameras;
performing distortion correction on the plurality of second original images; and
performing angle-perspective transformation and image filling processing on the plurality of second original images subject to the distortion correction processing according to the coordinates of preset mark points arranged in space and preset resolution and size of object panoramic parking image, so as to generate a plurality of second top-view images with same resolution.

8. The method for synthesizing parking images according to claim 6, further comprising:
generating the stencil matrices using the method for synthesizing parking images by acquiring a plurality of top-view images to be synthesized, wherein each of the plurality of top-view images is corresponding to a parking camera respectively, the resolution of the first top-view images is same as the resolution of a preset object panoramic parking image;
generating a plurality of stencil matrices corresponding to the plurality of first top-view images by identifying overlapping regions between effective pixel regions of the first top-view images, calculating overlapping weight value of each first top-view image in the overlapping regions and setting element values of matrix elements in the stencil matrices corresponding the pixel points as the overlapping weight values, the effective pixel regions being pixel regions where there are actual captured images; and
storing the generated a plurality of stencil matrices as system call files for subsequent synthesis of parking images.

9. A device for generating stencil matrices, comprising:
one or more processors;
a memory; and
one or more programs stored in the memory and configured to perform operations when executed by the one or more processors, wherein the operations comprise:
acquiring a plurality of top-view images to be synthesized, wherein each of the plurality of top-view images is corresponding to a parking camera respectively, the resolution of the first top-view images is same as the resolution of a preset object panoramic parking image;
generating a plurality of stencil matrices corresponding to the plurality of first top-view images by identifying overlapping regions between effective pixel regions of the first top-view images, calculating overlapping weight value of each first top-view image in the overlapping regions and setting element values of matrix elements in the stencil matrices corresponding the pixel points as the overlapping weight values, the effective pixel regions being pixel regions where there are actual captured images; and
storing the generated a plurality of stencil matrices as system call files for subsequent synthesis of parking images.

10. The device for synthesizing parking images according to claim 9, wherein the acquiring a plurality of first top-view images to be synthesized comprises:
receiving a plurality of first original images captured by a plurality of parking cameras;
performing distortion correction on the plurality of first original images; and
performing angle-perspective transformation and image filling processing on the plurality of first original images subject to the distortion correction processing according to the coordinates of preset mark points arranged in space and preset resolution and size of object panoramic parking image, so as to generate a plurality of first top-view image.

11. The device for synthesizing parking images according to claim 9, wherein the overlapping weight value is calculated by average weight method or distance weight method or angle weight method.

12. A device for synthesizing parking images, comprising:
one or more processors;
a memory; and
one or more programs stored in the memory and configured to perform operations when executed by the one or more processors, wherein the operations comprise:
acquiring a plurality of same second top-view images to be synthesized, wherein each of the plurality of second top-view images is corresponding to a parking camera respectively, the resolution of the second top-view images is same as the resolution of a preset object panoramic parking image;
calling a plurality of stencil matrices stored in advance, overlapping weight values corresponding to pixel points of the second top-view images being stored in matrix element of the stencil matrices, wherein the overlapping weight values mean ratios of pixel values of pixel points of each second top-view image of overlapping regions between effective pixel regions in the synthesized panoramic parking images, the effective pixel regions being pixel regions where there are actual captured images;
multiplying pixel values in the plurality of second top-view images and element values corresponding to the plurality of stencil matrices respectively to generate a plurality of third top-view images; and
overlapping and synthesizing the plurality of third top-view images to generate the panoramic parking image.

13. The device for synthesizing parking images according to claim 12, wherein the acquiring a plurality of second top-view images to be synthesized with same resolution comprises:
receiving a plurality of second original images captured by a plurality of parking cameras;
performing distortion correction on the plurality of second original images; and
performing angle-perspective transformation and image filling processing on the plurality of second original images subject to the distortion correction processing according to the coordinates of preset mark points arranged in space and preset resolution and size of object panoramic parking image, so as to generate a plurality of second top-view images with same resolution.
